(19) United States
(12) Patent Application Publication
(10) Pub. No.: US 2007/0003674 A1
(43) Pub. Date: Jan. 4, 2007

(54) Bagel toppings

(76) Inventor: Miles B. Wright, Mesa, AZ (US)

Correspondence Address: Wright Law Group, PLLC;Suite 2, 7201 West Oakland, Chandler, AZ, 85226, US

(21) Appl. No.: 11/479,727

(22) Filed: Jun. 30, 2006

Related U.S. Application Data
(60) Provisional application No. 60/695,288, filed on Jun. 30, 2005.

(51) Int. Cl. A21D 13/00

(52) U.S. Cl. 426/94

(57) ABSTRACT

A substantially flat and circular bagel topping, sized to fit a bagel, is disclosed. The bagel topping may be manufactured from a variety of foodstuffs, including various cheeses and the like. Certain embodiments of the present invention will further incorporate an aperture in the center of the substantially circular bagel topping, thereby conforming to bagels with a center hole as well. The most preferred embodiments of the present invention will be thin, circular slices, with each slice being individually pre-packaged within a plastic-like material to facilitate quick and easy dispensing and application of the bagel topping on the bagel.

### RELATED APPLICATION

This application claims the benefit of U.S. Provisional Patent Application No. 60/695,288, which application was filed on Jun. 30, 2005, which application is incorporated by reference in its entirety herein.

### BACKGROUND OF THE INVENTION

1. Technical Field

The present invention relates generally to the field of culinary arts and more particularly to the field of prepackaged foodstuffs.

2. Background Art

The world today is a place of ever-increasing hustle and confusion. The demands of everyday life and the hectic pace of living for most individuals and families allow for very little “down time” and other opportunities to “stop and smell the roses.” In days gone by, many meals would be painstakingly prepared with great care and the expenditure of a significant amount of time. No more. Today, most people simply don't have the luxery of spending as much time as they might like in the preparation of food. The advent of fast foods and prepackaged foods are but a few indicators of the ever-increasing growth of time-saving approaches to providing busy people with eating options that fit their hectic lifestyles.

Another casualty of the busy lifestyle so prevelant today is the near demise of breakfast as a meal. Instead of a nourishing breakfast with a variety of healthy choices, many people simply grab a bowl of prepared, sweetened breakfast cereal. While this may be a quick meal, it is hardly nourishing or even appetizing. Alternatively, some people may opt to grap a slice of bread or a bagel to supplement their morning meal. However, while a bagel may be a more nutritious choice than sugery cereal, it is also nutritionaly deficient in some respects. For example, while most bagels provide an adequate amount of carbohydrates, little protein is contained in a standard bagel. Additionally, the taste of a plain bagel is not acceptable to some individuals. In order to address these various shortcomings, it is common practice to slice a bagel in two halves and add various toppings to bagel, sandwich style. This is typically done to both enhance the nutritional value and to enhance the taste experience when consumed. Alternatively, the bagel may be eaten “open-faced” with a topping placed on the split bagel half.

While the addition of foodstuffs to bagels is well known, there are few prepared bagel toppings that can be quickly and easily added to a bagle without some effort. For example, while cream cheese is a popular addition to a bagel, it takes time to get the cream cheese out of the refrigerator and then to spread the cream cheese on the surface of the bagel. Some people also find it difficult to quickly and evenly distribute the cream cheese over the surface of the bagel and, accordingly, may not be satisfied with the uneven results. Further, the cold cream cheese is often somewhat difficult to spread and may damage the surface of the bagel when spread too quickly.

Additionally, while other types of prepared, pre-sliced toppings such as ham and american cheese may be placed, sandwich style, on a split bagel, the typical pre-sliced topping is generally square or rectangular in shape. These ill-fitting shapes are obviously aesthetically and practically mismatched when placed on the open face of a round bagel. The excess topping material hanging over the edge of the bagel must be painstakingly trimmed or consumed without consuming a corresponding amount of bagel. While these various toppings have been employed for years, they are obviously not well suited for the express purpose of topping a bagel. Accordingly, while these various known solutions are not without merit, all fall short of the desired goal for quickly and easily topping a bagel for enhanced nutrition and eating pleasure.

As shown by the previous discussion, without additional improvements in the form, content, packaging and shape of bagel toppings, the efficiency and enjoyment of eating bagels will continue to be suboptimal.

### BRIEF SUMMARY OF THE INVENTION

A substantially flat and circular bagel topping, sized to fit a bagel, is disclosed. The bagel topping may be manufactured from a variety of foodstuffs, including various cheeses and the like. Certain embodiments of the present invention will further incorporate an aperture in the center of the substantially circular bagel topping, thereby conforming to bagels with a center hole as well. The most preferred embodiments of the present invention will be thin, circular slices, with each slice being individually pre-packaged within a plastic-like material to facilitate quick and easy dispensing and application of the bagel topping on the bagel.

### BRIEF DESCRIPTION OF THE DRAWINGS

The preferred embodiments of the present invention will hereinafter be described in conjunction with the appended drawings, wherein like designations denote like elements and:

FIG. 1 is an exploded view of a bagel and bagel topping in accordance with a preferred exemplary embodiment of the present invention;

FIG. 2 is a plan view of a bagel topping in accordance with a preferred embodiment of the present invention;

FIG. 3 is a side view of a bagel topping in accordance with a preferred embodiment of the present invention;

FIG. 4 is a plan view of a bagel topping enclosed in a plastic wrapper in accordance with a preferred exemplary embodiment of the present invention; and

FIG. 5 is a flow chart for a method of implementing bagel toppings in accordance with a preferred exemplary embodiment of the present invention.

### DETAILED DESCRIPTION

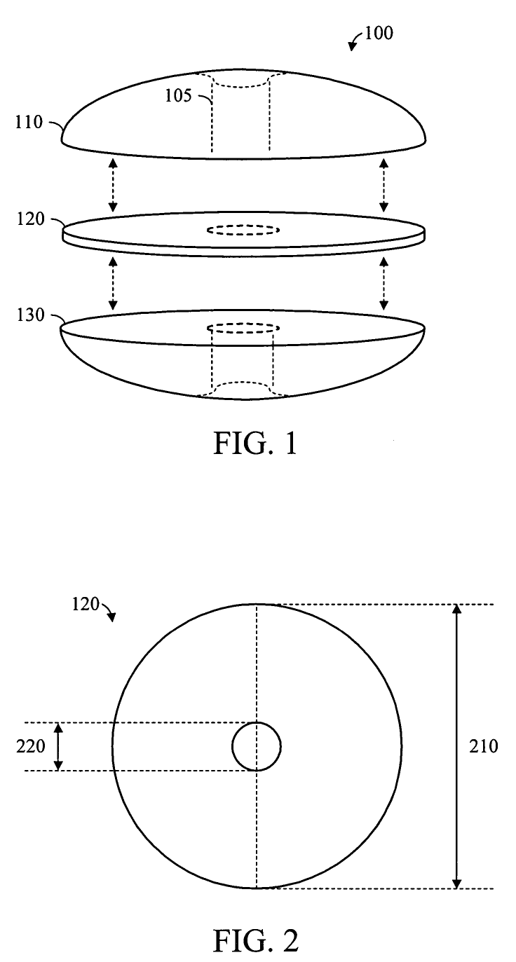

Referring now to FIG. 1, an exploded view of a bagel 100 and a bagel topping 120 in accordance with a preferred embodiment of the present invention is shown. As shown in FIG. 1, bagel 100 can be separated into two halves, half 110 and half 130. Bagel topping 120 may be manufactured from any appropriate foodstuff but in the most preferred embodiments of the present invention is manufactured from cream cheese. Depending on the manufacturer of bagel 100, bagel 100 may also have an optional indentation in the top or bottom and/or and aperture 105 that extends through the body of bagel 100. Those skilled in the art will recognize that bagel 100 may be provided in many different sizes, with varying diameters.

Bagel topping 120 most preferrably has a flat, substantially circular form with a diameter sized to be substantially equal to the diameter of bagel 100. Given that bagel 100 may be manufactured with a plurality of diameters, it is considered within the scope of the invention to provide bagel toppings 120 with the same or substantially similar diameters as the standard range of diameters for any and all commercially available bagels 100. In this fashion, an appropriately sized bagel topping 120 will be available for use with a wide range of bagels 100. As shown in FIG. 1, bagel 100 and bagel topping 120 are typically assembled in “sandwich” fashion with bagel topping 120 being placed between the halves 110 and 130.

One simple process for making cream cheese is set is set forth herein. This process is for a relatively small batch of cream cheese but may be adapted for larger quantities, if desired. Typically, 2 or 3 litres of skim or whole milk (cow or goat's milk, for example), or cream or raw milk will be combined with other ingredients.

The process is most preferrably conducted at room temperature, in the range of 20-24 degrees C. (68-75 degrees F.). Typically, 2 or 3 litres of skim or whole milk (cow or goat's milk, for example), or cream or raw milk will be combined with 200 ml mesophilic culture (10% by volume). In a clean pot, the milk mixture is pasteurized at 62 degrees C. or 145 F and held for approximately 20 minutes, if using raw milk. After pasteurization, the milk mixture is allowed to cool down to 20-24 degrees C. in a cool water bath. Next, 200 ml of mesophilic culture (10% by volume) is added to the milk. Alternatively, it would be possible to use ¼ tsp of mesophilic powder culture for 2 litres of milk, or V₂ tsp of mesophilic powder culture for 3 litres of milk, or even ¼ tsp mesophilic pellets. Next, 2-3 drops of liquid Rennet is added to the milk mixture and the mixture is stirred well to combine the ingredients.

Next, the pot containing the milk mixture is covered and the milk mixture is allowed to set at room temperature until a firm curd forms. This will typically take approximately 14-16 hrs. Once a firm curd has formed and some clear whey has been formed on the top of the curd, the entire curd is poured into a cheesecloth draining bag and drips for approximately 8-12 hours until the bag feels slightly damp. The cream cheese may then be removed from the bag and stored in a clean container. If desired, salt and/or fresh or dry herbs may be added to provide additional flavor for the cream cheese. Once formed, this cream cheese product will keep for approximately two weeks if refrigerated. If a longer shelf life is necessary, then preservatives may be added as well. Using the process set forth herein, the yield for the cream cheese would be approximately 20% by volume. Accordingly, starting with 3 litres of whole milk, it would be possible to produce approximately 600 grams of cheese (approximate 1⅓ pounds). Typically, the resulting cream cheese yield goes down as the fat content of the milk drops.

Those skilled in the art will recognize that other processes for making cream cheese may be utilized as well. These processes may be adapted for use in conjunction with the present invention wihthout undue experimentation. After the cream cheese has been obtained, it is necessary to form it into the desired shape for use in the preferred embodiments of the present invention. The most common form of cream cheese known is most likely the “block” form. Another common form of cream cheese is a spreadable paste stored in “tubs.” As previously explained, these existing options are at least somewhat deficient in certain ways.

In one preferred embodiment of the present invention, a cylindrical or “log-shaped” piece of cream cheese may be formed with the desired circumference (approximately equal to the circumference of a standard bagel) and then thin slices of cream cheese in the desired thickness may be sliced from the cylindrical piece of cream cheese, thereby forming the circular slices of the present invention. Depending on the application, an aperture may be formed in the cream cheese slice to more closely match the shape of the bagel.

In yet another preferred embodiment of the present invention, the cream cheese will be pressed flat into thin sheets of the desired thickness. Once the thin sheets of cream cheese have been formed, the desired circular shape set forth in the various preferred embodiments of the present invention can be formed by using a stamping process or other process suitable for the purposes of the present invention. Regardless of the process used to obtain the cream cheese slices, once the relatively thin, circular slices of cream cheese or other bagel topping have been manufactured, they are most preferrably wrapped in individual plastic wrappers to preserve the freshness of the product and to provide for convenient distribution and use.

Referring now to FIG. 2, a plan view of bagel topping 120 from FIG. 1 is shown. As shown in FIG. 2, bagel topping 120 has an outer diameter 210 and, optionally, an inner diameter 220. If bagel 100 of FIG. 1 has an aperture 105 formed in the middle of bagel 100, it may be desirable to remove a substantially circular portion of bagel topping 120, thereby forming an aperture, with the apertue having a diameter equal to inner diameter 220. This aperture may be as large or small as desired, thereby providing a method for optimizing the ratio or amount of bagel topping for the bagel. For example, if inner diameter 220 is very small, then more of bagel topping 120 will be provided. Conversely, if inner diameter 220 is increased, then less of bagel topping 120 will be provided for consumption. In the most preferred embodiments of the present invention, inner diameter 220 will be equal to approximately ⅕-⅙ of outer diameter 210.

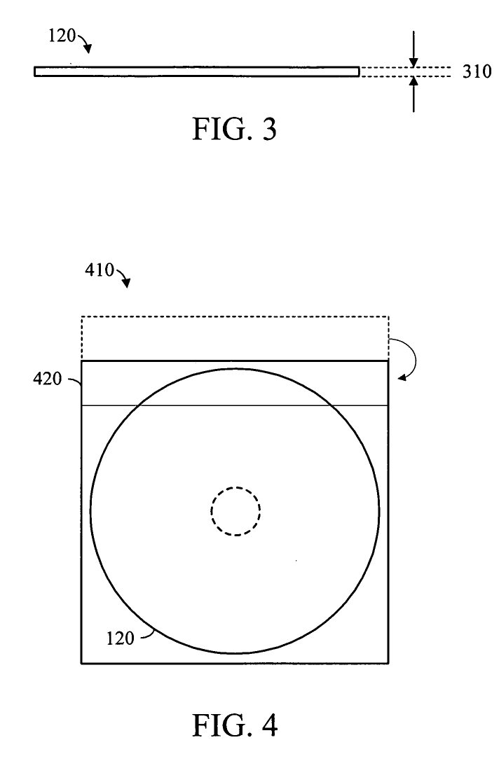

Referring now to FIG. 3, a side view of bagel topping 120 from FIG. 1 is shown. As shown in FIG. 3, bagel topping 120 has a thickness 310. Thickness 310 may be adjusted to provide the appropriate and desired ratio of bagel topping 120 to bagel 100 for maximum enjoyment during consumption. For example, if more bagel topping 120 is desired for each bite of bagel 100, then thickness 310 will be increased during the manufacturing process. Conversely, if less of bagel topping 120 is desired for each bite of bagel 100, then thickness 310 will be decreased during the manufacturing process. In this fashion, bagel topping 120 can be provided at the desired thickness. In the most preferred embodiments of the present invention, thickness 310 will be in a range between 1/16 of an inch and ½ inch

Referring now FIG. 4, a plan view of a bagel topping 120 enclosed in a plastic wrapper 410 in accordance with a preferred exemplary embodiment of the present invention is shown. As shown in FIG. 4, bagel topping 120 is enclosed within plastic wrapper 410 and repositionable flap portion 420 may be used to seal bagel topping 120 inside plastic wrapper 410. The use of plastic wrappers with repositionable flap portions to enclose individual portions of ready-to-serve foodstuffs, particularly cheese slices, is well known to those skilled in the art. In the most preferred embodiments of the present invention, plastic wrapper 410 is manufactured from a thin, transparent plastic film of the type typically used to preserve and distribute similar types of foodstuffs. Additionally, it is anticipated that certain preferred embodiments of the present invention, such as packaging for point-of-sale purchases at grocery stores, etc., will include a plurality of individually wrapped bagel toppings 120 in a cardboard container, allowing for the purchase of a plurality of individually wrapped bagel toppings in a single container.

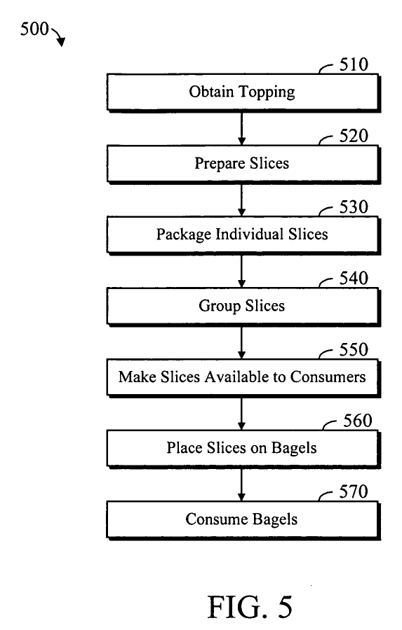

Referring now to FIG. 5, a flow chart for a method 500 of implementing a bagel topping in accordance with a preferred exemplary embodiment of the present invention is depicted. As shown in FIG. 5, a bulk version of the desired bagel topping is obtained (step 510). As previously explained, the desired bagel topping may be any type of bagel topping including cheese, meats, etc.

Next, the bagel topping is formed into subtantially circular slices (step 520) with a circumference that is approximately equal to a standard bagel. Once the slices have been prepared, the individual slices are packaged (step 530) and the slices are grouped together in the desired packaging units (step 540) and made available to consumers via any appropriate distribution methodology (step 550). Once the slices have been received by the consumer, the slices can be removed from the packaging, placed on bagels (step 560) and consumed (step 570).

In summary, the present invention provides for the quick and easy application of certain desired bagel toppings to bagels. By implementing one or more of the preferred embodiments disclosed herein, the consumption of bagels can be enhanced from both the nutritioal perspective and taste perspective. Lastly, it should be appreciated that the illustrated embodiments disclosed herein are preferred exemplary embodiments only, and are not intended to limit the scope, applicability, or configuration of the present invention in any way. Rather the foregoing detailed description provides those skilled in the art with a convenient roadmap for implementing the preferred exemplary embodiments of the present invention. Accordingly, it should be understood that various changes may be made in the function and arrangement of elements decribed in the various preferred embodiments without departing from the spirit and scope of the present invention as set forth in the appended claims.

1. A bagel topping comprising:
a flat and substantially circular slice of foodstuff, said flat and substantially circular slice of foodstuff comprising an outer diameter, an inner diameter, and a thickness.

2. The bagel topping of claim 1 wherein said outer diameter is not greater than 5 inches and wherein said inner diameter is less than 1 inch.

4. The bagel topping of claim 1 wherein said flat and substantially circular slice of foodstuff further comprises a thickness and said thickness is in a range between 1/16 of an inch and ½ inch.

5. The bagel topping of claim 1 further comprising:
an upper bagel half; and
a lower bagel half, said bagel topping being positioned between said upper bagel half and said lower bagel half.

6. The bagel topping of claim 1 further comprising a thin transparent plastic covering substantially enclosing said bagel topping.

7. The bagel topping of claim on wherein said bagel topping comprises cream cheese.

8. A method comprising the steps of:
separating a bagel into a first section and a second section;
placing a pre-formed thin and substantially circular foodstuff on said first section of said bagel, said pre-formed thin and substantially circular foodstuff comprising an outer diameter, and an inner diameter, and a thickness; and
placing said second section of said bagel on said substantialy circular foodstuff, thereby sandwiching said pre-formed thin sheet of substantially circular foodstuff between said first section and said second section.

9. The method of claim 8 wherein said outer diameter is not greater than 5 inches and wherein said inner diameter is less than 1 inch.

10. The method of claim 8 wherein said thickness is in a range between 1/16 of an inch and ½ inch.

11. The method of claim 8 wherein said bagel topping comprises cream cheese.

12. A method comprising the steps of:
obtaining a bagel topping;
preparing a plurality of substantially flat and circular slices of said bagel topping;
individually packaging said plurality of substantially flat and circular slices of said bagel topping in transparent plastic packaging;
packaging said plurality of substantially thin and circular slices of said bagel topping packaged in said transparent plastic packaging for distibution;
making said plurality of substantially thin and circular slices of said bagel topping packaged in said transparent plastic packaging available to consumers;
removing at least one of said plurality of substantially thin and circular slices of said bagel topping from said transparent plastic packaging;
placing said at least one of said plurality of substantially thin and circular slices of said bagel topping on a bagel; and
consuming said bagel and said bagel topping.

13. The method of claim 12 wherein each of said plurality of substantially flat and circular slices comprises an outer diameter, and an inner diameter, and a thickness.

14. The method of claim 13 wherein said outer diameter is not greater than 5 inches and wherein said inner diameter is less than 1 inch.

15. The method of claim 13 wherein said thickness is in a range between 1/16 of an inch and ½ inch.

16. The method of claim 12 wherein said bagel topping comprises cream cheese.
